(19) United States
(12) Patent Application Publication
(10) Pub. No.: US 2022/0126783 A1
(43) Pub. Date: Apr. 28, 2022

(54) SEATBELT RETRACTOR

(71) Applicant: ASHIMORI INDUSTRY CO., LTD., Osaka (JP)

(72) Inventors: Masao NISHIKAWA, Osaka (JP); Hiroki YAMAKAWA, Osaka (JP); Takao ISHIZAKI, Osaka (JP)

(73) Assignee: ASHIMORI INDUSTRY CO., LTD., Osaka (JP)

(21) Appl. No.: 17/509,644

(22) Filed: Oct. 25, 2021

(30) Foreign Application Priority Data
Oct. 26, 2020 (JP) 2020-178963

(51) Int. Cl. B60R 22/405; B60R 22/46

(52) U.S. Cl. CPC B60R 22/405; B60R 22/4676

(57) ABSTRACT

A seatbelt retractor includes: a housing; a winding drum configured to wind a webbing and rotatable in a winding direction and a pull-out direction of the webbing; a lock member coupled to the winding drum to be not rotatable relative to the winding drum when a force for pulling out the webbing is less than a predetermined value and to be rotatable relative to the winding drum when the force exceeds the predetermined value; an impact energy absorber provided between the winding drum and the lock member and configured to absorb impact energy by relative rotation between the winding drum and the lock member; and a bush made of resin. The lock member includes a tubular shaft support portion, and the winding drum includes a protrusion disposed inside the shaft support portion. The bush made of resin is provided between the shaft support portion and the protrusion.

### CROSS-REFERENCE TO RELATED APPLICATIONS

This application is based upon and claims the benefit of priority from prior Japanese patent application No. 2020-178963, filed on Oct. 26, 2020, the entire contents of which are incorporated herein by reference.

### TECHNICAL FIELD

The present disclosure relates to a seatbelt retractor including an impact energy absorber.

### BACKGROUND

A seatbelt retractor known in the related art prevents a webbing from being pulled out in an emergency such as a vehicle collision. In the seatbelt retractor, a winding drum that winds the webbing is rotatably housed between a pair of side walls of a housing.

The seatbelt retractor generally includes an impact energy absorber that absorbs impact energy acting on the body of an occupant in an emergency. The impact energy absorber is provided between the winding drum and a lock member disposed to face one side surface of the winding drum. The lock member is prevented from rotating in a direction in which the webbing is pulled out in an emergency, and is coupled to the winding drum to be not rotatable relative to the winding drum when a force for pulling out the webbing is less than a predetermined value and to be rotatable relative to the winding drum when the force for pulling out the webbing exceeds the predetermined value.

For example, the impact energy absorber is a torsion bar. The torsion bar is twisted and plastically deformed by the relative rotation between the lock member and the winding drum when the force for pulling out the webbing exceeds the predetermined value, thereby absorbing the impact energy.

For example, in a seatbelt retractor disclosed in JP 3,689,515 B2, a winding drum (referred to as a “bobbin” in JP 3,689,515 B2) has a center hole having a bottom on a side surface opposite to a lock member. A torsion bar is disposed inside the center hole. One end portion of the torsion bar is coupled to the winding drum at the bottom of the center hole of the winding drum, and the other end portion is coupled to the lock member.

In the seatbelt retractor of JP 3,689,515 B2, a fitting recess having a larger diameter than the center hole is provided on the side surface of the winding drum on the lock member side. The lock member includes a tubular boss portion (the torsion bar is disposed inside the boss portion) pivotally supported by the fitting recess. A bush is provided between an inner peripheral surface of the fitting recess and an outer peripheral surface of the boss portion in order to improve slidability. Accordingly, the frictional resistance during relative rotation between the lock member and the winding drum is reduced and the load during impact energy absorption is stabilized, and the rattling between the boss portion and the fitting recess is absorbed and abnormal noise is reduced.

In a seatbelt retractor disclosed in JP 4,006,827 B2, similarly to JP 3,689,515 B2, a fitting recess having a larger diameter than a center hole, into which a torsion bar is inserted, is provided on a side surface of a winding drum on a lock member side. A lock member (referred to as a “pawl holder” in JP 4,006,827 B2) includes a tubular boss portion (referred to as a “column” in JP 4,006,827 B2) disposed inside the fitting recess of the winding drum. An external thread is formed on an outer peripheral surface of the boss portion. A stopper nut (referred to as a “stopper member” in JP 4,006,827 B2) is screwed to the external thread. The stopper nut is fitted in the fitting recess of the winding drum to be not rotatable relative to the winding drum and to be movable in the axial direction, and moves in the axial direction by relative rotation between the lock member and the winding drum during impact energy absorption and abuts against a flange of the lock member, thereby restricting further relative rotation between the lock member and the winding drum. That is, an amount of the relative rotation (pull-out amount of the webbing) between the lock member and the winding drum is determined by the stroke of the stopper nut.

In the seatbelt retractor of JP 4,006,827 B2, a tubular portion is provided at a distal end of the boss portion. A bush is provided between the tubular portion and an inner peripheral surface of the fitting recess (see FIG. 10 of JP 4,006,827 B2), or that a ring member made of resin or rubber is provided between an outer peripheral surface of the distal end portion of the boss portion and the inner peripheral surface of the fitting recess to prevent abnormal noise due to vibration of the boss portion (see FIG. 11 of JP 4,006,827 B2).

### SUMMARY

One illustrative aspect of the present disclosure provides a seatbelt retractor including: a housing, a winding drum, a lock member, an impact energy absorber, and a bush. The housing includes a pair of side walls facing each other. The winding drum is configured to wind a webbing and housed between the pair of side walls to be rotatable around a rotation axis in a winding direction and a pull-out direction of the webbing. The winding drum has a first side surface and a second side surface. The lock member is disposed to face the first side surface of the winding drum. The lock member is coupled to the winding drum to be not rotatable relative to the winding drum when a force for pulling out the webbing is less than a predetermined value and to be rotatable relative to the winding drum when the force for pulling out the webbing exceeds the predetermined value. The lock member is prevented from rotating in the pull-out direction relative to the housing in an emergency. The impact energy absorber is provided between the winding drum and the lock member and is configured to absorb impact energy by relative rotation between the winding drum and the lock member. The bush is made of resin. The lock member includes a tubular shaft support portion centered on the rotation axis of the winding drum. The winding drum includes a protrusion disposed inside the shaft support portion and supported by the shaft support portion to be rotatable relative to the shaft support portion. The bush made of resin is provided between the shaft support portion of the lock member and the protrusion of the winding drum.

According to the above configuration, since the bush is provided between the shaft support portion of the lock member and the protrusion of the winding drum, the slidability of the shaft support portion of the lock member and the protrusion of the winding drum can be improved. Accordingly, the load during impact energy absorption can be stabilized. In addition, since the hush is made of resin, abnormal noise due to rattling of the protrusion in the shaft support portion can be reduced.

Further, since the bush is provided inside the tubular shaft support portion of the lock member, the bush can have an inner diameter larger than that of a bush provided in a fitting recess of a winding drum as in JP 3,689,515 B2, and the strength of the bush can be easily ensured. In addition, even when the stopper nut is provided as in JP 4,006,827 B2, a shape of the bush is not affected by a complicated cross-sectional shape of the recess that is fitted to the stopper nut, and it is not necessary to dispose the bush at the back of the recess as in JP 4,006,827 B2, and thus the workability for disposing the bush is good.

### BRIEF DESCRIPTION OF DRAWINGS

FIG. 1 is a perspective view of a seatbelt retractor according to an embodiment of the present disclosure;

FIG. 2 is an exploded perspective view of the seatbelt retractor in FIG. 1;

FIG. 3 is an exploded perspective view of the seatbelt retractor in FIG. 1;

FIG. 4 is an exploded perspective view of a housing unit;

FIG. 5 is an exploded perspective view of a winding drum unit;

FIG. 6 is an exploded perspective view of the winding drum unit;

FIG. 7 is a cross-sectional side view of a part of the winding drum unit;

FIG. 8 is a cross-sectional view taken along a line in FIG. 7;

FIG. 9 is a cross-sectional view taken along a line IX-IX in FIG. 7; and

FIG. 10 is an exploded perspective view of a winding drum unit of a seatbelt retractor according to a modification.

### DETAILED DESCRIPTION

When the bush is provided in the fitting recess of the winding drum as in the seatbelt retractor of JP 3,689,515 B2, the diameter of the fitting recess cannot be made too large considering the strength of the winding drum, and an inner diameter of the bush is accordingly relatively small. For this reason, the width and the thickness of the bush cannot be made large and it may be difficult to ensure the strength of the bush.

As in the seatbelt retractor of JP 4,006,827 B2, when the hush is provided between the tubular portion provided at the distal end of the boss portion and the inner peripheral surface of the fitting recess, since a cross-sectional shape of the fitting recess is a non-circular shape in order to fit the stopper nut in the fitting recess to be not relatively rotatable and to be movable in the axial direction, a shape of an outer peripheral surface of the bush is also non-circular shape. Therefore, alignment is required to assemble the bush. In addition, the workability is poor since it is necessary to dispose the bush at the back of the fitting recess.

Accordingly, illustrative aspects of the present disclosure may provide a seatbelt retractor in which strength of a hush is easily ensured and workability for disposing the bush is good.

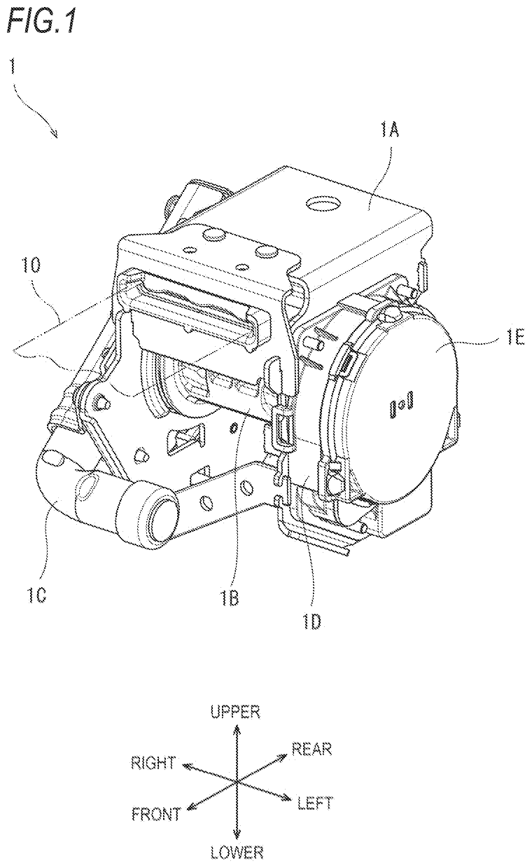

FIGS. 1 to 3 illustrate a seatbelt retractor 1 according to an embodiment of the present disclosure. The seatbelt retractor 1 prevents a webbing 10, which is a seatbelt, from being pulled out in an emergency such as a vehicle collision.

Specifically, the seatbelt retractor 1 includes a housing unit 1A, a winding drum unit 1B, a pretensioner unit 1C, a lock unit 1D, and a winding spring unit 1E.

Hereinafter, for convenience of description, an axial direction of the winding drum unit 1B is referred to as a left-right direction, a leftward and downward direction in FIG. 1 that is orthogonal to the left-right direction is referred to as a forward direction, and a direction opposite to the forward direction is referred to as a rearward direction. An upward direction in FIG. 1 that is orthogonal to the left-right direction and the front-rear direction is referred to as an upward direction and a. downward direction in FIG. 1 is referred to as a downward direction.

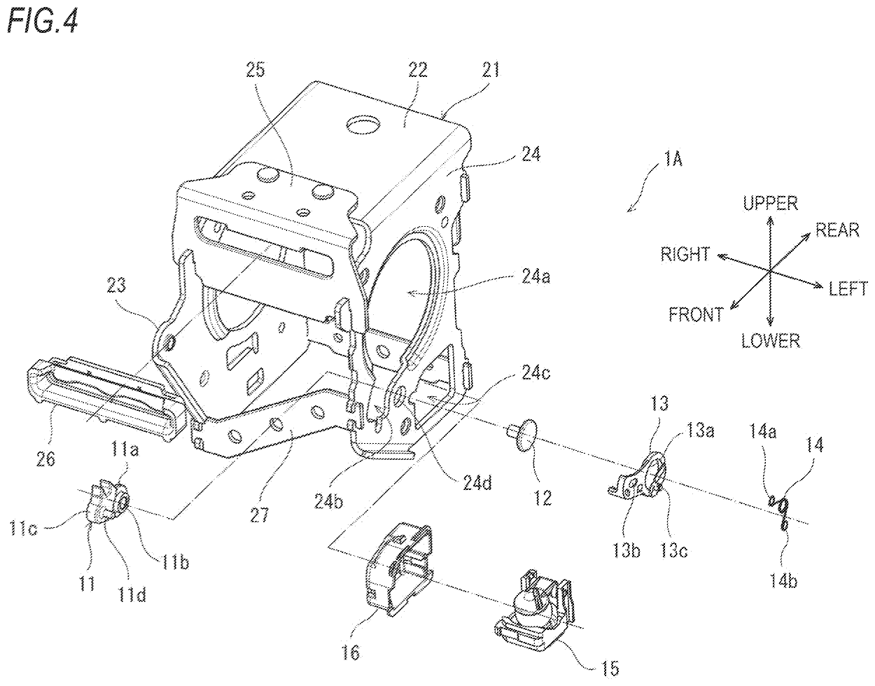

As illustrated in FIG. 4, the housing unit 1A includes a housing 21 made of sheet metal, a bracket 25 made of sheet metal and attached to the housing 21, and a protector 26 made of resin and attached to the bracket 25. The protector 26 has a rectangular tubular shape. The webbing 10 is inserted into the protector 26.

The housing 21 has a U-shaped cross section, and includes a back plate 22 fixed to a vehicle body and parallel in the left-right direction and the front-rear direction, and a pair of side walls 23, 24 bent from corresponding left and right sides of the back plate 22. The side walls 23. 24 face each other in the left-right direction. The side walls 23, 24 have circular openings 23a, 24a, respectively, through which the winding drum unit 113 is inserted.

The bracket 25 is attached to a front end portion of the back plate 22. Lower portions of front sides of the side walls 23, 24 are coupled by a coupling bar 27. Middle portions of rear sides of the side walls 23, 24 are coupled by a coupling bar 28, and lower portions of the rear sides are coupled by a coupling bar 29.

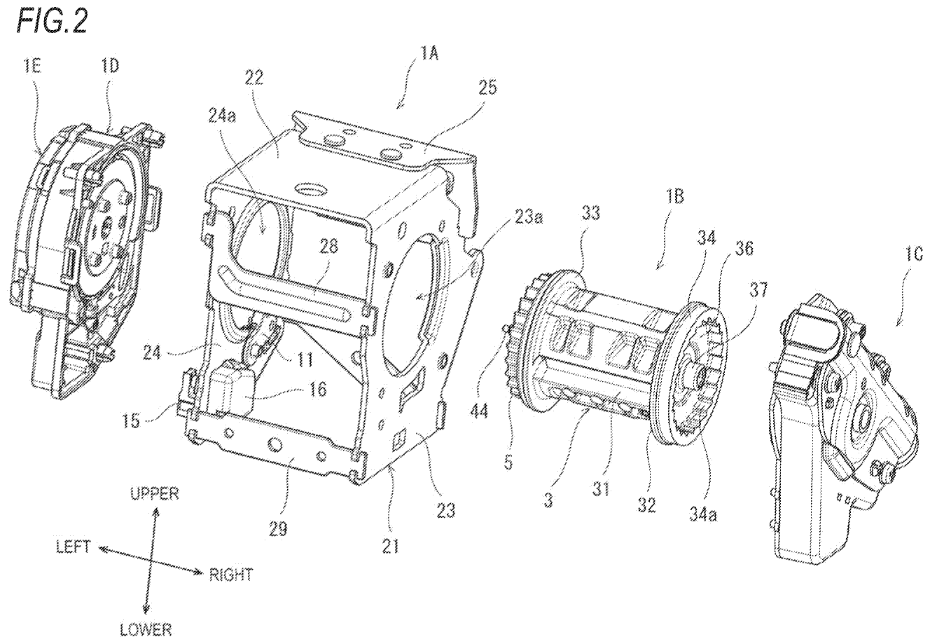

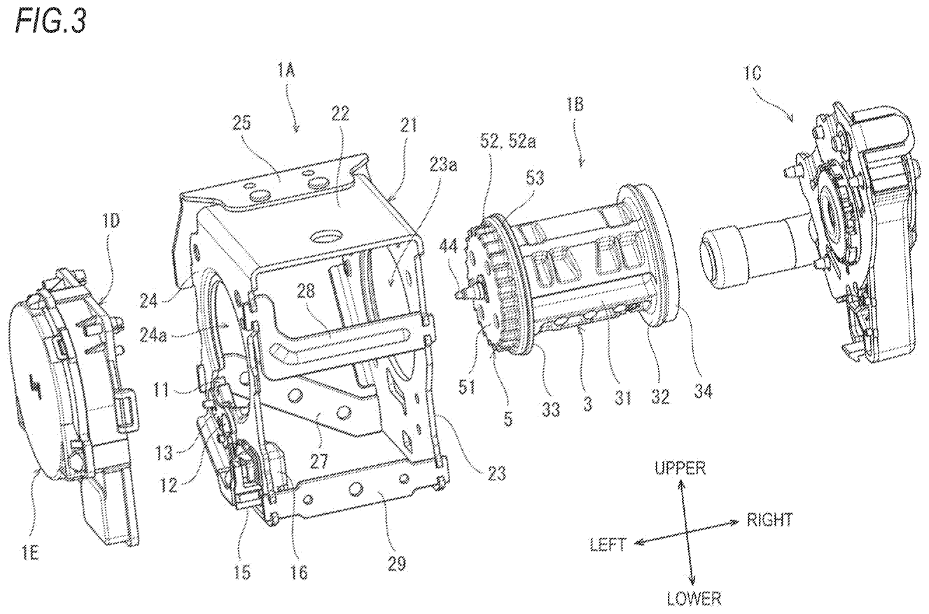

The winding drum unit 113 includes a winding drum 3 (see FIGS. 2 and 3) that winds the webbing 10. The winding drum 3 is housed between the side walls 23, 24 of the housing 21 to be rotatable in a winding direction and a pull-out direction of the webbing 10. The winding drum 3 has a left side surface and a right side surface. The left side surface and the right side surface respectively correspond to a first side surface and a second side surface of the present disclosure.

As illustrated in FIGS. 1 to 3, the pretensioner unit 1C is attached to the right side wall 23 of the housing 21, and the lock unit 1D is attached to the left side wall 24. The winding spring unit is attached to the lock unit 1D.

The pretensioner unit 1C rotates the winding drum 3 in the webbing winding direction during a vehicle collision. The winding spring unit 1E biases the winding drum 3 in the webbing winding direction. Configurations of the units 1C, 1E are described in detail in JP 6,074,243 B2, and thus descriptions thereof are omitted in this specification.

The winding drum unit 1B includes a lock member 5 facing the left side surface of the winding drum 3. In the present embodiment, a ratchet gear 52a is formed on the lock member 5, and a pawl 11 that engages with the ratchet gear 52a is swingably attached to the left side wall 24 of the housing 21.

More specifically, as illustrated in FIG. 4, the pawl 11 includes a base portion 11a located on an inner side (right side) of the side wall 24, a tubular boss portion 11b protruding leftward from the base portion 11a, a claw portion 11c located forward of the base portion 11a and thicker than the base portion 11a, and a pin 11d protruding leftward from the claw portion 11c.

The side wall 24 of the housing 21 has a notch 24b extending obliquely forward and downward from the opening 24a. The claw portion 11c of the pawl 11 is inserted into the notch 24b. The side wall 24 further has a circular through hole 24d right behind the notch 24b. The boss portion 11b of the pawl 11 is fitted into the through hole 24d. The boss portion 11b has a center hole, and a shaft portion of a pawl rivet 12 is fitted into the center hole from a left side of the side wall 24.

An operation piece 13 that swings integrally with the pawl 11 is disposed on the left side of the side wall 24. The operation piece 13 is has a fitting hole 13a to which a head of the pawl rivet 12 is fitted, and a through hole 13b into which the pin 11d of the pawl 11 is inserted. The operation piece 13 further has a pin 13c protruding leftward. One end 14b of a torsion spring 14 is engaged with the pin 13c, The torsion spring 14 biases the pawl 11 downward via the operation piece 13.

The side wall 24 has a substantially rectangular opening 24c below the opening 24a. A sensor cover 16 is inserted into the opening 24c. A vehicle sensor 15 is disposed in the sensor cover 16. The vehicle sensor 15 detects a large change in the acceleration of a vehicle (i.e., in a first emergency (for example, in a vehicle collision)).

Although not illustrated, the lock unit 1D includes a webbing sensor that detects rapid pulling out of the webbing 10 (i.e., in a second emergency). When an emergency is detected by the webbing sensor or the vehicle sensor 15, the lock unit 1D swings the pawl 11 upward and engages the claw portion 11c of the pawl 11 with the ratchet gear 52a of the lock member 5, thereby preventing the lock member 5 from rotating in the webbing pull-out direction relative to the housing 21.

More specifically, the lock unit 1D includes a clutch that rotates by a predetermined angle in the lock unit 1D. The other end 14a of the torsion spring 14 is engaged with the clutch. A configuration of the lock unit 1D is described in detail in JP 6,509,634, and thus a further description of the lock unit 1D is omitted in this specification.

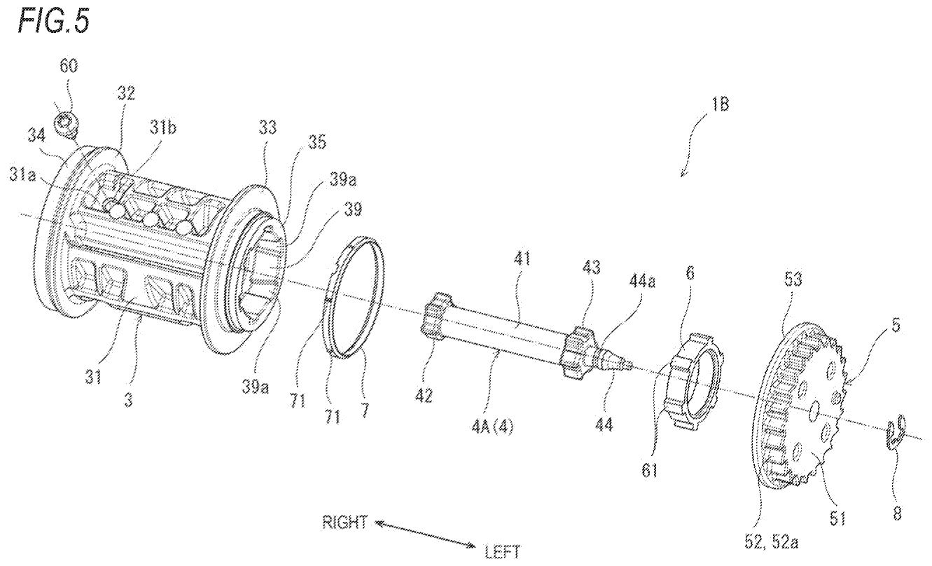

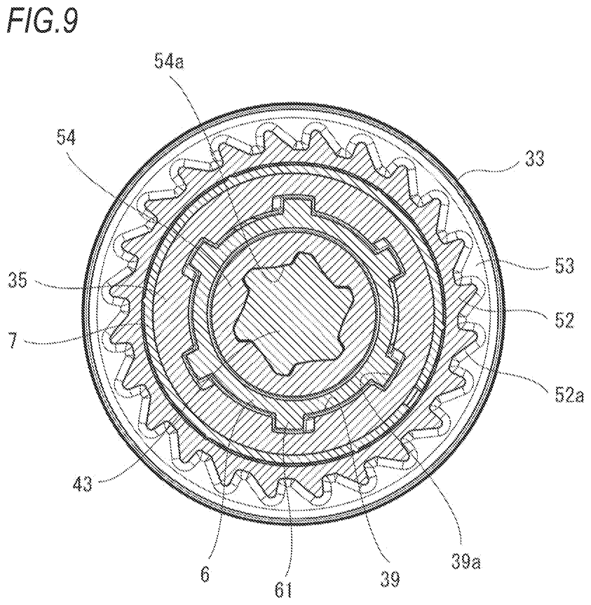

Next, the winding drum unit 113 will be described in detail with reference to FIGS. 5 to 9. The winding drum unit 1B includes an impact energy absorber 4, a stopper nut 6, a bush 7, and an E-type retaining ring 8 in addition to the winding drum 3 and the lock member 5.

The impact energy absorber 4 is provided between the winding drum 3 and the lock member 5, and absorbs impact energy acting on the body of an occupant in an emergency by relative rotation between the winding drum 3 and the lock member 5. When the lock member 5 is coupled to the winding drum 3 via the impact energy absorber 4, the lock member 5 is not rotatable relative to the winding drum 3 when a force for pulling out the webbing 10 is less than a predetermined value α, and is rotatable relative to the winding drum 3 when the force for pulling out the webbing 10 exceeds the predetermined value α.

The winding drum 3 has a center hole 38 having a bottom that is adjacent to the right side surface of the winding drum 3 and the pretensioner unit 1C. In the present embodiment, the impact energy absorber 4 is a torsion bar 4A disposed inside the center hole 38. The predetermined value α is a load when the torsion bar 4A is twisted and plastically deformed.

More specifically, the winding drum 3 is manufactured by die casting of aluminum alloy or the like, and includes a hollow drum body 31, a pair of flanges 32, 33 extending radially outward from corresponding two end portions of the drum body 31, and a bottom wall 36 blocking the inside of the drum body 31 on a right side that is adjacent to the pretensioner unit 1C. The winding drum 3 further includes a peripheral wall 34 protruding rightward from the right flange 32, and a protrusion 35 protruding leftward from a left end surface (surface flush with an outer side surface of the flange 33) of the drum body 31.

The peripheral wall 34 has a tubular shape centered on a central axis of the winding drum 3, and has an inner diameter larger than an outer diameter of the drum body 31. The peripheral wall 34 has a gear 34a on an inner peripheral surface thereof. The gear 34a receives a rotational force from the pretensioner unit 1C. A contour of the protrusion 35 is a circular shape centered on the central axis of the winding drum 3, and has a diameter smaller than the outer diameter of the drum body 31.

The winding drum 3 has a recess 39 recessed from a distal end surface of the protrusion 35 centered on the rotation axis of the winding drum 3. For this reason, the protrusion 35 has a tubular shape. A boss portion 37 protrudes rightward from the center of the bottom wall 36. The boss portion 37 is rotatably supported by the pretensioner unit 1C.

The stopper nut 6 is disposed inside the recess 39. The lock member 5 has a shape for covering the stopper nut 6 and the protrusion 35.

More specifically, the lock member 5 includes a disk portion 51 facing the distal end surface of the protrusion 35, a tubular shaft support portion 52 extending rightward from a peripheral edge portion of the disk portion 51 and centered on the rotation axis of the winding drum 3, and a flange 53 extending radially outward from a distal end portion of the shaft support portion 52. The protrusion 35 of the winding drum 3 is disposed inside the shaft support portion 52 and is supported by the shaft support portion 52 to be rotatable relative to the shaft support portion 52. The ratchet gear 52a is formed on an outer peripheral surface of the shaft support portion 52.

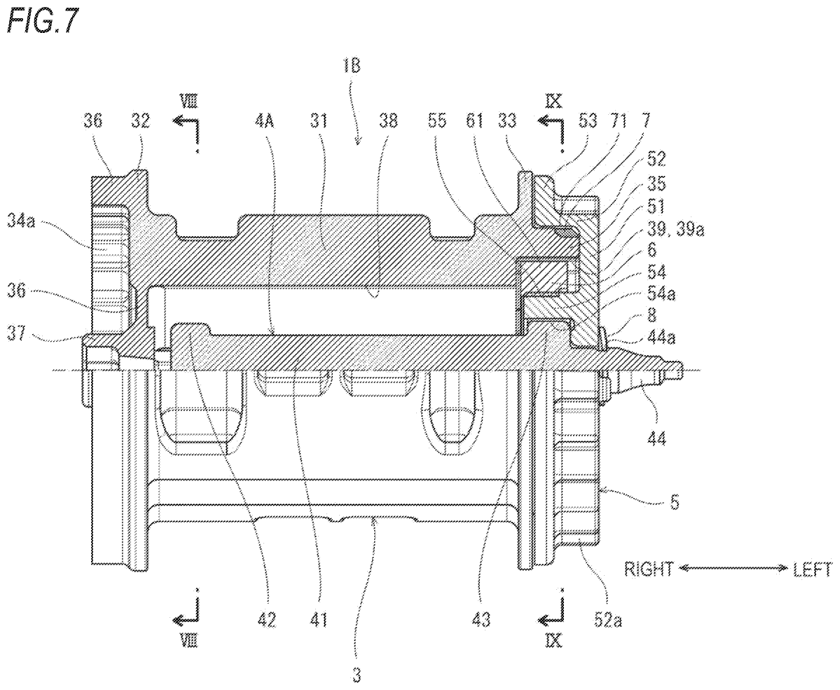

The lock member 5 further includes an annular boss portion 54 that protrudes rightward from the disk portion 51 to be located in the recess 39 of the winding drum 3. An external thread 55 (see FIG. 7) is formed on an outer peripheral surface of the boss portion 54. The stopper nut 6 is screwed to the external thread 55.

The stopper nut 6 is fitted into the recess 39 to be movable in the axial direction of the winding drum 3 relative to the winding drum 3 and to be not rotatable relative to the winding drum 3. That is, a plurality of grooves 39a extending in the axial direction of the winding drum 3 are dispersedly provided in the circumferential direction on an inner peripheral surface of the recess 39. On the other hand, the stopper nut 6 includes a plurality of ribs 61 that are fitted into the grooves 39a and protrude radially outward. The thickness of the stopper nut 6 is smaller than the depth of the recess 39.

The stopper nut 6 moves in the axial direction due to the relative rotation between the lock member 5 and the winding drum 3 during impact energy absorption, and abuts against the disk portion 51 (base end of the boss portion 54) of the lock member 5, thereby restricting further relative rotation between the lock member 5 and the winding drum 3. That is, an amount of the relative rotation (pull-out amount of the webbing) between the lock member 5 and the winding drum 3 is determined by the stroke of the stopper nut 6.

The torsion bar 4A includes a shaft portion 41 and spline coupling portions 42, 43 provided at corresponding two end portions of the shaft portion 41. The right coupling portion 42 is coupled to the winding drum 3 at the bottom of the center hole 38 of the winding drum 3. The left coupling portion 43 is coupled to the boss portion 54 of the lock member 5. That is, the bottom of the center hole 3$ has a fitting hole 36a to which the coupling portion 42 is fitted, and the boss portion 54 has a fitting hole 54a to which the coupling portion 43 is fitted. Since the coupling portion 42 is fitted into the fitting hole 36a, the torsion bar 4A is not rotatable relative to the winding drum 3. Since the coupling portion 43 is fitted into the fitting hole 54a, the torsion bar 4A is not rotatable relative to the lock member 5. In other words, one end of the torsion bar 4A is non-rotatably coupled to the winding drum 3 at the bottom of the center hole 38, and the other end of the torsion bar 4A is fitted into the boss portion 54 to be not rotatable relative to the lock member 5. Here, the other end and the one end of the torsion bar 4A respectively correspond to a first end and a second end of the present disclosure.

When the force for pulling out the webbing 10 exceeds the predetermined value α, the shaft portion 41 of the torsion bar 4A is twisted and plastically deformed to absorb impact energy, and the winding drum 3 rotates relative to the lock member 5.

In the present embodiment, the torsion bar 4A includes a distal end portion 44 extending through the disc portion 51 of the lock member 5. The distal end portion 44 is rotatably supported by the lock unit 1D. The torsion bar 4A may not include the distal end portion 44, and a shaft portion rotatably supported by the lock unit 1D may be provided on the lock member 5.

The E-type retaining ring 8 that retains the lock member 5 is attached to a portion of the distal end portion 44 that protrudes from the disk portion 51. That is, the distal end portion 44 has a groove 44a for engagement with the E-type retaining ring 8. The E-type retaining ring 8 has a curved shape. When the E-type retaining ring 8 is attached to the distal end portion 44, the E-type retaining ring 8 is elastically deformed by being attached to the groove 44a while being abutted against the disk portion 51 of the lock member 5, and retains the lock member 5 in a state in which the lock member 5 is pressed against the winding drum 3.

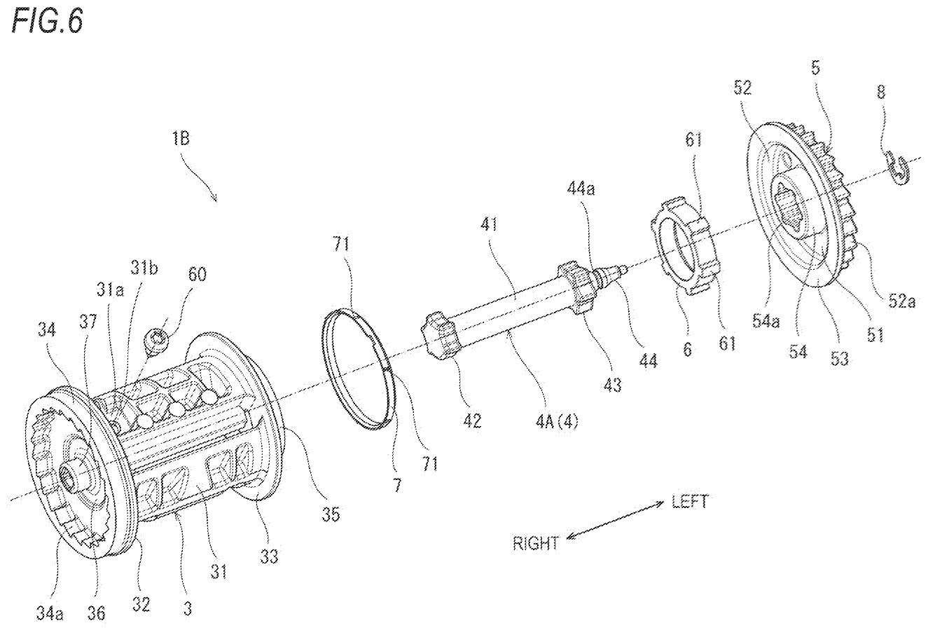

As illustrated in FIGS. 5 and 6, an attachment recess 31a recessed by a predetermined depth is formed in the vicinity of the flange 32 in the drum body 31 of the winding drum 3, and an attachment hole 31b penetrating to the center hole 38 is formed in a bottom surface portion of the attachment recess 31a.

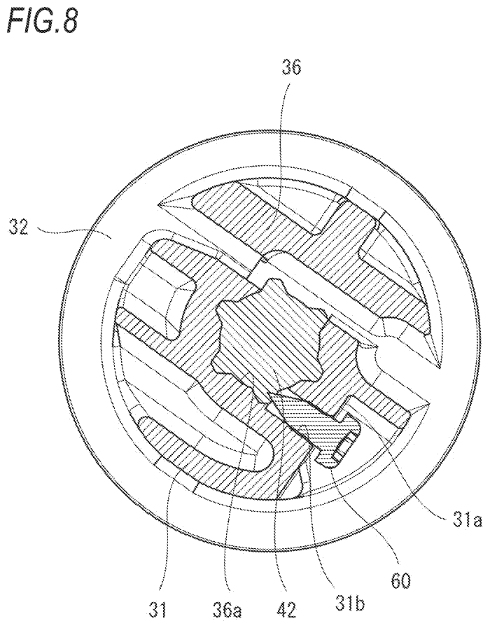

As illustrated in FIG. 8, in a state where the coupling portion 42 of the torsion bar 4A is fitted into the fitting hole 36a of the center hole 38, a fixing screw 60 formed of a steel material or the like is screwed into the attachment hole 31b and a distal end of the fixing screw 60 is pressed against the coupling portion 42, whereby the coupling portion 42 is coupled to the fitting hole 36a to be not movable in the axial direction without rattling and the torsion bar 4A is held in the center hole 38.

The resin bush 7 is provided between an inner peripheral surface of the shaft support portion 52 of the lock member 5 and an outer peripheral surface of the protrusion 35 of the winding drum 3. In the present embodiment, the protrusion 35 includes a large diameter portion on a base side and a small diameter portion on a distal side. The small diameter portion is fitted into the bush 7.

The resin forming the bush 7 is not particularly limited and is, for example, polyacetal. In the present embodiment, the bush 7 includes a plurality of ribs 71 that protrude radially outward and are spaced with each other in the circumferential direction. That is, the bush 7 is in surface contact with the outer peripheral surface of the protrusion 35, and is in line contact with the inner peripheral surface of the shaft support portion 52 at a plurality of positions. However, the ribs 71 may protrude radially inward, which is contrary to the present embodiment. In other words, the bush 7 may be in surface contact with the inner peripheral surface of the shaft support portion 52 and in line contact with the outer peripheral surface of the protrusion 35 in a plurality of positions.

The height of the ribs 71 of the bush 7 may be larger than a clearance between the bush 7 and the inner peripheral surface of the shaft support portion 52, and a distal end of the ribs 71 of the bush 7 may be deformed when the shaft support portion 52 of the lock member 5 and the protrusion 35 of the winding drum 3 are assembled. Accordingly, the bush 7 can be easily assembled between the shaft support portion 52 of the lock member 5 and the protrusion 35 of the winding drum 3 without rattling, and abnormal noise due to rattling of the protrusion 35 in the shaft support portion 52 can be reduced. When the ribs 71 protrude radially inward, the height of the ribs 71 may be larger than the clearance between the bush 7 and the outer circumferential surface of the protrusion 35.

As described above, in the seatbelt retractor 1 of the present embodiment, the bush 7 is provided between the shaft support portion 52 of the lock member 5 and the protrusion 35 of the winding drum 3. Accordingly the slidability of the shaft support portion 52 of the lock member 5 and the protrusion 35 of the winding drum 3 can be improved. Accordingly, the load during impact energy absorption can be stabilized. In addition, since the bush 7 is made of resin, abnormal noise due to rattling of the protrusion 35 in the shaft support portion 52 can be reduced.

Further, since the bush 7 is provided in the tubular shaft support portion 52 of the lock member 5, the bush 7 can have an inner diameter larger than that of a bush provided inside a fitting recess of a winding drum as in JP 3,689,515 B2, and the strength of the bush 7 is easily ensured. The stress σ acting on the bush 7 is σ=F÷(D×L), where F is a force radially acting on the bush 7 from the protrusion 35 of the winding drum 3, D is an inner diameter of the bush 7, and L is the axial length of the bush 7. Accordingly, it is advantageous for the bush 7 to have a large inner diameter.

In addition, a shape of the bush 7 is not affected by a complicated cross-sectional shape of the recess 39 that is fitted to the stopper nut 6, and it is not necessary to dispose the bush at the back of the recess as in JP 4,006,827 B2, and thus the workability for disposing the bush is good.

Further, in the present embodiment, since the E-type retaining ring 8 has a curved shape, rattling of the lock member 5 in the axial direction of the winding drum 3 can be prevented by the E-type retaining ring 8.

### Modifications

The present disclosure is not limited to the embodiment described above and various modifications can be made without departing from the scope of the present disclosure.

For example, the stopper nut 6 may not be provided as in JP 3,689,515 B2. If the stopper nut 6 is provided, an amount of the relative rotation (pull-out amount of the webbing) between the lock member 5 and the winding drum 3 can be determined by the stroke of the stopper nut 6.

The pretensioner unit 1C may not be provided. In this case, the winding spring unit 1E may be attached to the side wall 23 that is opposite to the lock unit 1D.

Further, the bush 7 may not include the ribs 71, and the bush 7 may be in surface contact with both the inner peripheral surface of the shaft support portion 52 and the outer peripheral surface of the protrusion 35 over the entire surface. If the bush 7 includes the ribs 71, more excellent slidability can be obtained as compared with a configuration in which the bush 7 is in surface contact with both the inner peripheral surface of the shaft support portion 52 and the outer peripheral surface of the protrusion 35 over the entire surface.

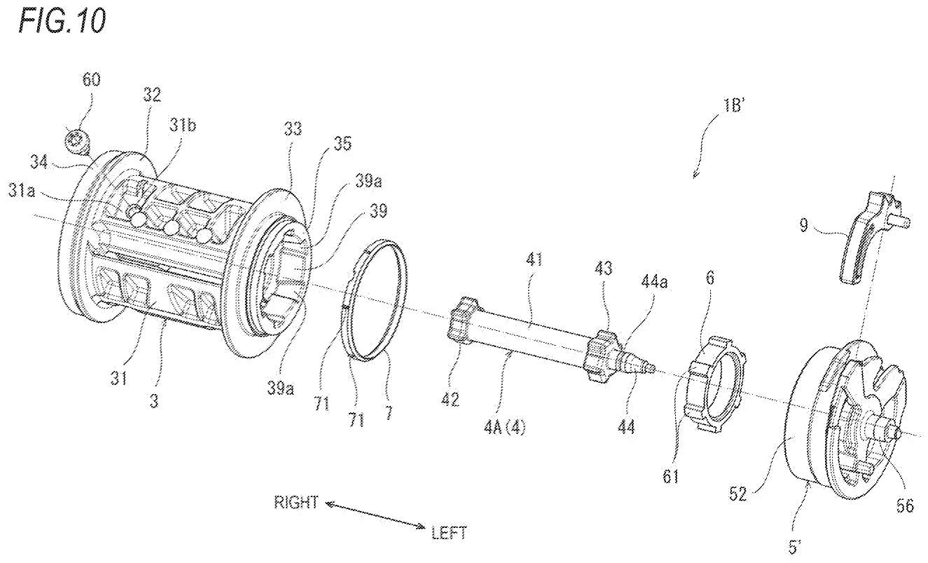

In addition, the configuration of the lock member 5 can be appropriately changed except for the shaft support portion 52. For example, a lock member 5′ having a configuration as illustrated in FIG. 10 may be employed. The lock member 5′ includes a shaft portion 56 that is rotatably supported by the lock unit 1D. The lock member 5′ is not formed with the ratchet gear 52a, and a pawl 9 is held as in JP 3,689,515 B2 and JP 4,006,827 B2. In an emergency, the pawl 9 is moved by the lock unit 1D from a retracted position in which the pawl 9 is located inside the contour of the lock member 5′ to a protruding position in which the pawl 9 protrudes outside the contour. In this case, although not illustrated, a ratchet gear with internal teeth is formed on an inner peripheral surface of the opening 24a of the side wall 24 of the housing 21.

The impact energy absorber 4 is not limited to the torsion bar 4A as long as the impact energy absorber 4 absorbs the impact energy by the relative rotation between the winding drum 3 and the lock member 5 (or 5′). For example, the impact energy absorber 4 may be a wire or the like that absorbs the impact energy by being bent and deformed by the relative rotation between the winding drum 3 and the lock member 5 (or 5′).

As discussed above, the disclosure may provide at least the following illustrative, non-limiting aspects.

The bush may include a plurality of ribs that. protrude radially inward or radially outward and are spaced with each other in a circumferential direction. According to this configuration, more excellent slidability can be obtained as compared with a configuration in which the bush is in surface contact with both the inner circumferential surface of the shaft support portion and the outer circumferential surface of the protrusion over the entire surface.

In particular, if the height of the ribs of the bush is larger than a clearance between the bush and the inner peripheral surface of the shaft support portion or the outer peripheral surface of the protrusion, a distal end of the ribs of the bush is deformed when the shaft support portion of the lock member and the protrusion of the winding drum are assembled. Accordingly, the bush can be assembled between the shaft support portion of the lock member and the protrusion of the winding drum without rattling, and abnormal noise due to rattling of the protrusion in the shaft support portion can be reduced.

For example, the winding drum may have a recess that is recessed from a distal end surface of the protrusion and that is centered on the rotation axis of the winding drum, and the lock member may include a disk portion facing a distal end surface of the protrusion, and a boss portion that protrudes from the disk portion and is located in the recess.

The boss portion may have an external thread on an outer peripheral surface thereof, and the seatbelt retractor may further include a stopper nut that is fitted into the recess to be movable in an axial direction of the winding drum relative to the winding drum and to be not rotatable relative to the winding drum and that is screwed with the external thread. According to this configuration, an amount of the relative rotation (pull-out amount of the webbing) between the lock member and the winding drum can be determined by the stroke of the stopper nut.

For example, the winding drum may have a center hole having a bottom adjacent to the second side surface of the winding drum. The impact energy absorber may be a torsion bar that is disposed inside the center hole and have a first end and a second end. The second end is coupled to the winding drum at the bottom of the center hole to be not rotatable relative to the winding drum. The boss portion may have an annular shape and the first end of the torsion bar may be fitted into the boss portion to be not rotatable relative to the lock member.

The torsion bar may include an E-type retaining ring that retains the lock member. The torsion bar may extend through the disk portion of the lock member. The E-type retaining ring may be attached to a portion of the torsion bar that protrudes from the disk portion of the lock member. The E-type retaining ring may have a curved shape to press the lock member against the winding drum. According to this configuration, rattling of the lock member in the axial direction of the winding drum can be prevented by the E-type retaining ring.

According to the present disclosure, it is possible to provide a seatbelt retractor in which strength of a bush is easily ensured and workability for disposing the bush is good.

What is claimed is:

1. A seatbelt retractor comprising:
a housing including a pair of side walls facing each other;
a winding drum configured to wind a webbing, the winding drum being housed between the pair of side walls to be rotatable around a rotation axis in a winding direction and a pull-out direction of the webbing, the winding drum having a first side surface and a second side surface;
a lock member disposed to face the first side surface of the winding drum, the lock member being coupled to the winding drum to be not rotatable relative to the winding drum when a force for pulling out the webbing is less than a predetermined value and to be rotatable relative to the winding drum when the force for pulling out the webbing exceeds the predetermined value, the lock member being prevented from rotating in the pull-out direction relative to the housing in an emergency;
an impact energy absorber provided between the winding drum and the lock member and configured to absorb impact energy by relative rotation between the winding drum and the lock member; and
a bush made of resin, wherein
the lock member includes a tubular shaft support portion centered on the rotation axis of the winding drum,
the winding drum includes a protrusion disposed inside the shaft support portion and supported by the shaft support portion to be rotatable relative to the shaft support portion, and
the bush made of resin is provided between the shaft support portion of the lock member and the protrusion of the winding drum.

2. The seatbelt retractor according to claim 1, wherein the bush includes a plurality of ribs that protrude radially inward or radially outward and that are spaced with each other in a circumferential direction.

3. The seatbelt retractor according to claim 1, wherein
the winding drum has a recess that is recessed from a distal end surface of the protrusion and that is centered on the rotation axis of the winding drum, and
the lock member includes a disk portion facing the distal end surface of the protrusion, and a boss portion that protrudes from the disk portion and is located in the recess.

4. The seatbelt retractor according to claim 3, wherein
the boss portion has an external thread on an outer peripheral surface thereof, and
the seatbelt retractor further comprises a stopper nut that is fitted into the recess to be movable in an axial direction of the winding drum relative to the winding drum and to be not rotatable relative to the winding drum, the stopper nut being screwed with the external thread.

5. The seatbelt retractor according to claim 4, wherein
the winding drum has a center hole having a bottom adjacent to the second side surface of the winding drum,
the impact energy absorber is a torsion bar disposed inside the center hole and having a first end and a second end, the second end being coupled to the winding drum at the bottom of the center hole to be not rotatable relative to the winding drum, and
the boss portion has an annular shape, and the first end of the torsion bar is fitted into the boss portion to be not rotatable relative to the lock member.

6. The seatbelt retractor according to claim 5, further comprising:
E-type retaining ring that retains the lock member, wherein
the torsion bar extends through the disk portion of the lock member,
the E-type retaining ring is attached to a portion of the torsion bar that protrudes from the disk portion of the lock member, and
the E-type retaining ring has a curved shape to press the lock member against the winding drum.
